(19) United States
(12) Patent Application Publication
(10) Pub. No.: US 2019/0200623 A1
(43) Pub. Date: Jul. 4, 2019

(54) GLUTEN-FREE COMPOSITIONS

(71) Applicant: Sharyn Carlesso, Greta West (AU)

(72) Inventor: Sharyn Carlesso, Greta West (AU)

(21) Appl. No.: 16/301,901

(22) PCT Filed: Jun. 2, 2017
(86) PCT No.: PCT/AU2017/050535

§ 371 Date: Nov. 15, 2018

(30) Foreign Application Priority Data
Jun. 3, 2016 (AU) 2016902155

(51) Int. Cl. A21D 10/00; A21D 13/043; A21D 13/047; A21D 13/066

(52) U.S. Cl. CPC A21D 10/005; A21D 13/043; A21D 13/80; A21D 13/066; A21D 13/047

(57) ABSTRACT

The present disclosure relates generally to flour compositions for use in baking and other culinary applications. In particular, the disclosure relates to flour compositions comprising popcorn flour, and their use as gluten-free substitutes for wheat and other gluten-containing flours.

### FIELD

The present disclosure relates generally to flour compositions for use in baking and other culinary applications. In particular, the disclosure relates to flour compositions comprising popcorn flour, and their use as gluten-free substitutes for wheat and other gluten-containing flours.

### BACKGROUND

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Coeliac disease is an autoimmune condition caused by gluten, a protein found in wheat, rye, barley and oats, and results in damage to the small intestine. Coeliac disease can lead to poor nutrient absorption often causes digestive symptoms such as bloating, abdominal pain and diarrhoea. It can also cause anaemia, low iron levels and excessive tiredness. Treatment of coeliac disease involves a strict and lifelong gluten-free diet.

Gluten intolerance or gluten insensitivity is a condition with symptoms similar to coeliac disease, without the damage to the small intestine, and individuals suffering from gluten intolerance or insensitivity report an improvement in their condition when gluten is eliminated from their diet.

While the reasons are unclear, the number of individuals suffering from coeliac disease or gluten insensitivity is on the rise. Coupled with the increasing trend towards health and wellbeing, whereby some individuals choose to eliminate or reduce the amount of gluten in their diets, even when it isn't medically required, there has been in recent years an explosive rise in the range of “gluten-free” products now available on the supermarket shelf, as well as a plethora of cook books, blogs and websites dedicated to gluten free cooking. Typical gluten-free replacements for wheat flour include rice flour, corn flour, tapioca flour, buckwheat flour, besan flour, coconut flour, potato flour, and mixtures thereof.

Gluten acts as a binder and provides structure and elasticity, as well as aiding moisture retention, and a common drawback of many gluten-free flours is that when substituted for wheat flour in many baking and cooking applications, the resulting product may characteristically be more dense and heavy, and/or fragile than its wheat flour equivalent. Additional agents, such as xanthan and/or guar gums, or ground seeds, such as psyllium, flax or chia, are typically used in an attempt to mimic the functions of gluten. Furthermore, the use of strongly flavoured flours, such as buckwheat, or the addition of ground seeds can also affect the taste of the food. In addition, a gluten-free diet may be at risk of providing insufficient fibre, since typical high fibre sources, such as whole wheat flours, are necessarily omitted.

In comparison to other gluten free flours, such as those mentioned above, popcorn flour, made from popped popping corn varieties, has received comparatively little attention as a wheat flour substitute, despite potential nutritional benefits due to its high fibre (approximately 15 g per 100 g), vitamin, and mineral, and polyphenol content. References to the use of popcorn flour in baking and other cooking applications tend to be restricted to combination with wheat flour, such as in the preparation of “popcorn bread”, or its use where the resulting product is texturally different compared to that prepared from wheat flour.

There is a need for a gluten-free flours that can be used in baking and other cooking applications that may provide a more palatable texture and/or flavor, and/or more closely mimic taste and/or texture results achieved by wheat flour, and thereby provide the consumer with a more palatable and familiar product.

### SUMMARY

It has now been found that popcorn flour, made from popped popcorn, when combined with potato flour in certain proportions can be used in baking and cooking applications and may afford baked and other edible products that more closely resemble those made from wheat flour, for example in rise, texture or appearance.

Accordingly, in a first embodiment, there is provided a flour composition comprising popcorn flour and potato flour in a (w/w) ratio of about 1:1 to about 3:1. In still further embodiments, the (w/w) ratio of popcorn flour to potato flour ratio is about from about 1:1 to about 2:1.

In a further embodiment, there is provided a dough, batter, pastry, or dry powdered mixture to which may be added wet ingredients to afford said dough, batter or pastry, comprising a flour composition comprising popcorn flour and potato flour in a (w/w) ratio of about 1:1 to about 3:1. In still further embodiments, the (w/w) ratio of popcorn flour to potato flour ratio is about from about 1:1 to about 2:1.

In another embodiment, there is provided a flour composition comprising popcorn flour and potato flour in a volume to volume ratio of about 3:1, wherein the popcorn flour has a density in the range of about 60 g to about 160 g per cup.

In some embodiments, the flour composition may comprise one or more additional gluten free flours. In other embodiments, the flour composition may consist essentially of popcorn flour and potato flour. Optionally, additional agents, such as raising agents, flavouring agents, flavour enhancers, sweeteners, thickeners, preservatives, antioxidants, anti-caking agents, etc may be added to the flour compositions of the disclosure and mixtures contains such.

In a further embodiment, there is provided a food product pre-mix composition comprising popcorn flour and potato flour in a (w/w) ratio of about 1:1, to about 3:1, and one or more additional ingredients for preparing said food product.

Still another aspect provides the use of popcorn flour and potato flour in a (w/w) ratio of about 1:1 to about 3:1 in the preparation of a food product.

### DESCRIPTION

Throughout this specification and the claims which follow, unless the context requires otherwise, the word “comprise” and variations such as “comprises” and “comprising” will be understood to imply the inclusion of a stated integer or step or group of integers but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the invention defined.

Those skilled in the art will appreciate that the invention described herein is susceptible to variations and modifications other than those specifically described. It is to be understood that the invention includes all such variations and modifications which fall within the spirit and scope. The invention also includes all of the steps, features, compositions and compounds referred to or indicated in this specification, individually or collectively, and any and all combinations of any two or more of said steps or features.

The singular forms “a”, “an” and “the” include plural aspects unless the context clearly dictates otherwise.

The term “invention” includes all aspects, embodiments and examples as described herein.

As used herein, “about” refers to a quantity, value or parameter that may vary by as much as 20%, or 15%, more particularly by 10%, 5%, or 1-2% of the stated quantity, value or parameter, and includes at least tolerances accepted within the art. When prefacing a recited range of values, it is intended to apply to both upper and lower limits of the range. It is to be understood that such variations do not extend to variations that materially alter the working of the invention.

Volume measurements referred to herein, for example “cup”, “tablespoon” (tblspn) etc, refer to Australian standard metric measurements.

Popcorn flour is a finely powdered/milled form of popped popping corn. Popping corn is characterized by a high hard-starch content that “explodes” through the hull when heated. Any suitable variety or cultivar of popcorn, e.g. Zea mays everta or flint corn, may be used. Common varieties or cultivars include butterfly, mushroom, Thunderpop, Ontos Oval. Baby Rice, Gourmet Black, Tender White, Mini Blue, Mini Strawberry and Glass Bead, although it will be appreciated that any suitable variety, including hybrids, of popping corn may be used. The popping corn may be popped using any method, such as with oil or butter, in the microwave, steam or air popping. In some preferred embodiments, the popcorn is popped in the absence of oil or butter, for example, air popped. The popped kernel is referred to as the flake and two forms are commonly produced: “butterfly” or “snowflake”, and “mushroom”. Depending on the variety of corn, both forms of flake may be produced from a single species, or alternatively, some hybrids produce exclusively one form or the other. Any form, or mixture thereof, may be used to prepare the popcorn flour. Thus in some embodiments, “butterfly” form popcorn is used to make the popcorn flour. In other embodiments, “mushroom” form is used. In still other embodiments, a combination of both forms may be used. Popcorn flour can be prepared by comminution, for examples by milling (e.g. cutting or grinding) popped popcorn until the desired consistency, e.g. a flour, is achieved. The popped popcorn may be first subjected to an initial comminution step to reduce initial particle size before subjecting to a further milling step. Some examples of a suitable popcorn flour consistency are described in the Examples. Thus, depending on the type of popcorn and the degree and method used for milling in producing the popcorn flour, the volume of popped popcorn may be reduced by at least about 25%, or by at least about 30%, or by at least about 35% or by at least about 40% or by at least about 50%, or by at least about 60% or by at least about 65%, or by at least about 70%, or by at least about 75%, or by about 80% or by about 90% or by at least about 95%. In some preferred embodiments, the popped popcorn is milled to a size such that when combined with potato flour, preferably in a volume to volume ratio of popcorn flour to potato flour of about 3:1, the flour composition can be substituted for wheat flour on about a volume for volume basis. In some embodiments, the popcorn flour is milled to a consistency such that 1 cup of milled popcorn flour has a weight in the range of about 60-160 g, such as about 70-120 g, for example, about 65 g, or about 70 g, or about 75 g, or about 80 g, or about 85 g, or about 90 g, or about 95 g, or about 100 g or about 105 g, or about 110 g or about 115 g, or about 120 g, or about 125 g, or about 130 g, or about 135 g, or about 140 g, or about 145 g, or about 150 g, or about 155 g. In some further embodiments, 1 cup of the popcorn flour has a weight of from about 80-110 g. Optionally, the milled popped popcorn may be sieved or screened to remove large pieces or to achieve a desired particle size or density.

Potato flour is derived from cooked and ground potatoes and is available commercially from supermarkets and health food shops. Potato flour has a density of about 169 g per cup.

The flour compositions may be prepared by combining the popcorn flour and potato flour, optionally with one or more additional agents as described herein, by any suitable means, for example, by stirring, sifting or shaking, by hand or by use of a suitable device, such as planetary mixers or blenders.

The present disclosure relates to a flour composition comprising popcorn flour and potato flour. The proportions of popcorn flour and potato flour may be conveniently expressed as a (w/w) ratio, such as of about 1:1 to about 3:1. In some embodiments, the (w/w) ratio of popcorn flour to potato flour is about: 1.2:1, 1.4:1, 1.5:1, 1.6:1, 1.8:1, 2:1, 2.2:1, 2.4:1, 2.5:1, 2.6:1, or 2.8:1. The relative proportions of popcorn flour to potato flour may also be expressed as a w/w %. Accordingly, in some embodiments there is provided a flour composition comprising popcorn flour and potato flour, wherein the popcorn flour is present in at least about 50%, or at least about 55%, or at least about 65% or at least about 65% or at least about 70% or up to about 75% (by weight of total weight of popcorn flour and potato flour). For example a ratio of about 1:1 may also be expressed as about 50% popcorn flour and about 50% potato flour, and a ratio of 3:1 may also be expressed as 75% popcorn flour and 25% potato flour

In some embodiments, the volume ratio of popcorn flour to potato flour is about 3:1 (e.g. ¾ cup of popcorn flour and ¼ cup of potato flour), wherein the popcorn flour has a density in the range of about 60-160 g per cup, such as 70-120 g per cup or about 80-110 g per cup.

In some advantageous embodiments, flour compositions of the disclosure can be used as a wheat flour substituent in the preparation of baked foods and other food products which typically contain wheat flour. Accordingly, in some non-limiting examples, the flour compositions described herein may be used in pastries, doughs, and batters, to prepare the likes of cookies, biscuits, slices, tray bakes, brownies, cakes, puddings, tarts, pies, breads, pasta, noodles, muffins, crackers, crumbs, doughnuts, pastries, crumpets, dumplings, scones, pancakes, pikelets, crepes, flat breads, wrap and pocket breads, pizza bases, noodles, and wonton wrappers.

Depending on the food, the wheat flour may be replaced by the flour compositions of the disclosure in any suitable amount, e.g. weight for weight, volume for volume, or fractions or multiples thereof. In some embodiments, 1 cup of wheat flour, for example self raising or all purpose (plain) flour, is replaced with about 2- or about 2½ cups of popcorn/potato flour of the disclosure. In other embodiments, the flour compositions of the disclosure may replace wheat flour on about an equivalent volume basis, for example, 1 cup of wheat flour may be substituted with about 1 cup of flour composition. In some embodiments the flour compositions may replace wheat flour on about an equivalent weight for weight basis, for example about 100 g of flour composition can replace about 100 g of wheat flour. In some advantageous embodiments, the flour compositions may be used as a direct replacement for wheat flour, without the need for additional agents such as emulsifiers, binders or gums. It will be understood that depending on the food product to be prepared substitution quantities may differ from product to product or recipe to recipe, and the skilled person will be able to determine suitable replacement quantities and ratios through reasonable trial and error.

It will be understood that in some embodiments, the flour compositions of the disclosure or food products containing said flour compositions may further comprise one or more additional gluten free flours, including, but not limited to, rice flour, corn (maize) flour, tapioca flour, buckwheat flour, besan flour, coconut flour, teff flour, sorghum flour, potato flour, and mixtures thereof. In alternative embodiments, the flour compositions consist essentially of popcorn flour and potato flour or the food products contain the flour compositions as the only flour. In any one or more of these embodiments, the flour composition may optionally contain or more other agents or ingredients, such as raising agents (e.g. bicarbonate of soda or baking powder), salt and/or other flavours, including, herbs and/or spices (such as parsley, mint, coriander, and basil, cumin, coriander, chili, cayenne pepper, black pepper, white pepper, fennel, cinnamon, nutmeg, allspice, and star anise), sweeteners, flavour enhancers, and anti-caking agents. In still further embodiments, the flour composition consists of popcorn flour and potato flour, that is to say, no further flours, agents or ingredients.

Another embodiment of the disclosure provides a food product pre-mix, such as a cake, cookie, pancake, brownie, pudding or muffin pre-mix, which contains the popcorn and potato flour, together with one or more other dry ingredients required to prepare said product and to which one or more wet ingredients may added to prepare said product. The pre-mix may be packaged either as a single mixture, or may comprise two or more packages wherein one or more components are separately packaged. The premix may be packaged in bulk, for use, for example in catering, bakeries etc, or in some embodiments, the pre-mix is packaged for purchase by individual consumers. The pre-mix may be packaged, together with instructions for making the food product.

Exemplary, but non-limiting, dry ingredients may include salt, sugars (e.g cane sugar, fructose, sucrose, lactose, glucose, dextrose); sugar substitutes and sweeteners (such as erythritol, isomalt, lactitol, maltitol, sorbitol, and xylitol); chocolate chips or pieces; powdered egg; powdered milk; dried fruit; seeds (such as pepitas, sunflower seeds, chia, flax, and psyllium); nuts (such as almonds, hazelnuts, pecans, peanuts, cashews); coconut; whey; flavours, such as cocoa, vanilla, almond, cheese, mono-sodium glutamate; and herbs and spices (for example as described herein); food colours (natural and/or artificial, e.g. chlorophyll, carotenoids, flavonoids, caramel); starch (e.g. maize, arrowroot); vegetable gums (e.g. guar, xanthan gum); preservatives (e.g. sulfites); anti-caking agents (e.g. triclacium phosphate); emulsifiers (e.g. soy, lecithin, mono- and di-glycerides of fatty acids); thickeners (e.g. arrowroot, cornstarch); anti-oxidants (e.g. ascorbic acid, tocopherol 306,); acidity regulators (e.g. calcium carbonate); preservatives; humectants; mineral salts; and raising agents (e.g. sodium bicarbonate and baking powder).

In some embodiments, the flour composition or food product pre-mix does not contain or require an additional binder such as a vegetable gum, e.g. xanthan or guar gum, and/or a ground seed such as psyllium, flax or chia. In some embodiments, the flour composition or food product pre-mix does not contain any other gluten free flour.

Wet/liquid ingredients to be added to the pre-mix may include, but are not limited to, one or more of water, stock, milk (dairy, and non dairy, such as rice, almond, coconut), butter, oil (e.g. canola , sunflower, vegetable, olive, coconut), buttermilk, yoghurt, cream, sour cream, crème frache, soft cheeses (e.g. fetta, ricotta, cream, mozzarella), coconut water, vinegar, soda, beer, fruit juices (e.g. citrus juices, such as limes, oranges and lemons), honey, golden syrup, maple syrup, agave syrup, rice malt syrup, treacle, margarine, shortening and eggs.

Some embodiments of the disclosure will now be further described with reference to the following examples, which are provided for the purpose of illustration and are not to be construed as limiting the generality herein before described.

### EXAMPLES

### Preparation of Popcorn and Potato Flour Composition

Popcorn seeds were obtained either from Green Harvest, Queensland (hybrid variety between “butterfly” and “mushroom” type) or Freedom Foods (“butterfly type”). Australian standard metric measurements were used: 1 cup=250 ml, 1 tblspn=20 ml, 1 tspn=5 ml.

“TASTY” brand potato flour, or potato flour purchased from a health food shop (100% potato flour) was used. 1 Cup potato flour weighs about 169 g.

### Example 1

Popcorn flour was prepared by placing (2 cups) of air popped popcorn (butterfly type) in a kitchen blender for 20-30 seconds, until a fine flour was produced. 1 cup popped popcorn produced approximately ⅔ cup popcorn flour.

Popcorn flour, as prepared above, and potato flour were mixed together thoroughly with a spoon at a proportion of 2 cups of popcorn flour to ¼ cup potato flour. 4 Cups of the flour composition prepared in this manner is about 150 g, which can be used to replace about 2 cups wheat flour, that is, 2 cups (approx. 75 g) of popcorn/potato flour can be substituted for 1 cup wheat flour. The w/w ratio of popcorn flour to potato flour was about 1:1.

The following recipes illustrate some embodiments of the disclosure where 1 cup wheat flour is replaced with 2 cups of the exemplary popcorn/potato flour, as described above. No further agents were added. Wheat Flour Recipes (WFR) are listed first followed by the Popcorn Flour Recipe (PFR)

### Example 1-1—Pancakes

Gluten-free pancake mixes also typically require the presence of emulsifying or binding agents, such as xanthan or guar gums in an attempt to achieve “fluffy” pancakes obtained by the use of wheat flour. Nevertheless, many such recipes can still result in dense, stodgy or stiff pancakes.

(WFR): 1 cup flour, 1 cup milk, 1 egg, 1 tspn bicarb, dash vinegar, pinch salt,. (PFR): 2 cups popcorn/potato flour, ¾ cup milk, 1 egg, 1 tspn bicarb, dash vinegar, pinch salt.

(1 cup milk provides a thinner pancake if the mixture is used immediately, in which case, ¾ cup liquid creates the perfect thick pancake. Otherwise, if 1 cup milk is used, allow mixture to stand for 10-15 minutes to thicken up).

Result: The PCR afforded a light, fluffy, thick, silky smooth and flexible pancake, on par to that achieved by the WFR. PCR savoury pancakes, where the milk was replaced by stock, and the salt and vinegar were omitted, were also prepared and afforded similar results.

### Example 1-2—Chocolate Cake

Cakes made with conventional gluten-free flours, typically require the addition of xanthan and/or guar gum to achieve an acceptable light texture.

(WFR) 1 Cup SR (self raising) Flour, 1 cup caster sugar, 1 tspn vanilla, 3 tblspn cocoa, 3 tblspn butter, ½ cup milk, 2 eggs.

(PFR) 2 cups popcorn/potato flour, 1 cup caster sugar, 1 tspn bicarb (to make SR) 1 tspn vanilla, 3 tblspn cocoa, 3 tblspn butter, ½ cup milk, 2 eggs.

Result: The cake prepared with the PFR resulted in a soft, moist, beautifully light chocolate cake very much on par with the WFR, but lighter. The cake held together just as well as that prepared by the WFR.

### Example 1-3—Chocolate Chip Cookies

Gluten free cookies are often described as crumbly, fragile or dry.

(WFR) 125 g butter, ½ cup sugar, ½ cup brown sugar, 1 egg, 1 and ¾ cups SR Flour, ½ tspn salt, 125 g choc chips.

(PFR) 125 g butter, ½ cup sugar, ½ cup brown sugar, 1 egg, 3.5 cups popcorn/potato flour, 1 tspn baking powder (for SR), ½ tspn salt 125 g choc chips.

Result: The PFR cookies were soft and chewy with a crunchy outer, having the same texture and taste as the WFR cookies.

### Example 1-4—Pasta

Traditional (wheat flour) pasta relies on gluten for its structure and “al dente” texture when cooked. Many commercially available gluten free pasta products, typically made from corn, tapioca and rice flours do not afford the same textural and flavour experience as traditional wheat pasta. Consumers report that gluten-free pasta product is very easily overcooked resulting in a mushy or gummy product and the cooked pasta is prone to breaking or falling apart. Home made gluten free pasta recipes often require the presence of xanthan and guar gums, or other binding agents to avoid a dry and crumbly dough that is difficult to work.

(WFR): 2.3 cups flour, 3 eggs, 1 tblspn oil

(PFR): 4.6 cups popcorn/potato flour, 3 eggs, 1 tblspn oil

Result: The PRF pasta was on par for texture and stability to home made WFR pasta; light, silky smooth and almost fluffy when cooked. The cooked pasta twirled well, without breaking, and was very stable.

### Example 1-5—Golden Syrup Dumplings

(WFR): Syrup mixture—½ cup brown sugar, 1 tblspn golden syrup, 1 tblspn butter, 1 cup water

Dumpling mixture—1 cup self raising flour, 1 tblspn sugar, 1 tblspn butter, milk to mix to a dough consistency

(PFR): Syrup mixture—½ cup brown sugar, 1 tblspn golden syrup, 1 tblspn butter, 1 cup water

Dumpling mixture—2 cups popcorn flour mix, 1 tspn bicarb soda, 1 tblspn sugar, 1 tblspn butter, milk to mix to a dough consistency

Results—The PFR resulted in light, moist, risen dumplings similar to the wheat flour recipe. They held well and did not break up at all. The popcorn was more prominent in flavour than any other recipe trialled but quite tasty.

### Example 2

225 g of popped popcorn (approximately 6 litres) was initially reduced in size using a Kitchenaid™ grater attachment to produce approximately 2.5 litres of ground popped popcorn. The ground popcorn was then further milled in a Retsel Mil-Rite™ electric stone mill to produce approximately 2.5 cups of popcorn flour. The popcorn flour had a texture and consistency between commercial plain wheat flour and wholemeal flour. 1 cup of popcorn flour weighed about 90g.

¾ Cup (about 68 g) of popcorn flour produced in this manner was combined with ¼ cup potato flour (about 42 g) to produce 1 cup of flour composition (about 110 g) with a popcorn flour:potato flour w/w ratio of about 1.6 to 1. This flour was used on a cup for cup replacement of wheat flour in the recipes described below. In each instance, the result was on par with that achieved using wheat flour.

### Example 2-1 Vanilla Almond Cake

1 cup popcorn/potato flour mix, mixed with 1 tspn baking powder

1 cup caster sugar

1 tspn vanilla

½ tspn almond extract

3 tblspn butter

½ cup milk

2 eggs

Mix together well and bake in a moderate oven for 45 minutes.

### Example 2-2 Plain Biscuits

125 g butter

¾ cup castor sugar

1 egg

2 cups of popcorn/potato flour mix, mixed with 1 tspn baking powder

Cream butter and sugar, add egg and mix in flour. Bake

### Example 2-3 Muffins

⅓ cup vegetable oil

2 cups of popcorn/potato flour mix, mixed with 1 tspn baking powder

¾ cup milk (or a little more if needed)

2 eggs

Mix until just combined. Bake.

### Example 2-4 Date Loaf

1 cup dates

1 egg

30 g butter

¾ cup brown sugar

2 cups of popcorn/potato flour mix, mixed with 1 tspn baking powder

1 cup boiling water

½ tspn bicarbonate soda

In saucepan melt butter and sugar, add dates, boiling water and soda and mix in flour. Pour into a loaf tin and bake in a moderate oven.

### Example 2-5 Chocolate Self Saucing Pudding

For pudding:

1 cup popcorn/potato flour mixed with 1 tspn baking powder

½ cup sugar

1 tblspn melted butter

½ cup milk

2 tspn cocoa

1 beaten egg

Place dry ingredients into a bowl, add butter, egg and milk, Mix and pour into a baking dish.

For sauce:

½ cup brown sugar

1 dessertspoon cocoa

1¼ cups boiling water

Sprinkle dry ingredients on top of pudding batter, then pour boiling water evenly over the top.

Bake for 45 min in a moderate oven.

### COMPARATIVE EXAMPLES

### Comparative Example 1

A commercial gluten-free pancake mix (rice flour, maize flour, cane sugar, fructose, raising agents (disodium diphosphate, sodium bicarbonate), flavour, salt, tricalcium phosphate, guar) purchased at the supermarket and prepared in accordance with the instructions.

Result: A thick, stodgy and very stiff pancake.

### Comparative Example 2

The pancake recipe of Example 1-1 was prepared using 100% popcorn flour prepared as described in Example 1.

Result: This produced a flat pancake, with no body and almost a “crepe” like texture. Although cooked well on the outside, it was undercooked in the middle.

### Comparative Example 3

The replacement of potato flour with alternative gluten-free flours was investigated. Flour blends using popcorn flour prepared according to Example 1 and either rice flour (approximately 167 g per cup) or corn flour (approximately 120 g per cup) to replace potato flour, in the same volume proportions as described in Example 1 above, were prepared and used to make pancakes in an analogous manner to that described in Example 1-1.

Result: Pancakes made with the rice flour blend were very dry, dense and weighty. Pancakes made with corn flour were not as dry and dense as those made from the rice flour blend, but had a rubbery texture.

### Comparative Example 4

The proportion of potato flour in the composition described in the Example 1 above was doubled, i.e. 2 cups popcorn flour prepared according to Example 1 and ½ cup potato flour, and used to prepare pancakes as above. The w/w ratio of popcorn flour to potato flour was about 1:2.

Result: The resulting pancakes were rubbery and stodgy in texture.

### Comparative Example 5

A plain butter cake recipe was prepared by replacing the wheat flour with a mixture of a commercially available gluten free flour (rice and maize flour) purchased from the supermarket, and 100% popcorn flour prepared according to Example 1

Result: The cake was dry and resembled a bread in taste and texture.

### Comparative Example 6

Further experiments were trialled using various volume ratios of potato flour and popcorn flour prepared by a double milling procedure as outlined in Example 2 and having a density of about 80 g per cup. The flour compositions were used to bake chocolate cake, vanilla almond cake and chocolate chip cookies as previously described.

A popcorn flour composition comprising ⅞ cup of popcorn flour and ⅛ cup potato flour per cup of composition (equivalent of about 70 g popcorn flour to about 21 g potato flour—a w/w ratio of greater than 3:1) resulted in a cake with a stodgy centre, a heavy texture and unpleasant taste.

A popcorn flour composition comprising ⅝ cup of popcorn flour and ⅜ cup of potato flour per cup of composition (equivalent to about 50 g of popcorn flour to about 63 g potato flour—a w/w ratio of about 1:1.25) resulted in a cake that held together but was very heavy and almost not cooked enough. The cake contained a large air bubble which formed a top skin separate from the rest of the cake.

When ¼ cup tapioca/arrowroot flour was substituted for ¼ cup potato flour in the same cake recipe i.e. ¾ cup popcorn flour and ¼ cup tapioca flour/arrowroot flour, the cake stuck to the tin, had a large air bubble separating the top layer from the body of the cake, and was stodgy and wet and had a very unpleasant flavour.

When the same ¾ cup popcorn flour and ¼ cup tapioca flour/arrowroot flour (approximately 135 g per cup) mixture was used bake cookies, the cookies spread very thin and flat and did not hold together, falling apart immediately. The taste was unpleasant.

1. A flour composition comprising popcorn flour and potato flour in a (w/w) ratio of about 1:1 to about 3:1.

2. The flour composition of claim 1, wherein the (w/w) ratio is in the range of about 1:1 to about 2:1.

3. The flour composition of claim 2, wherein the (w/w) ratio is about 1.2:1.

4. A flour composition comprising popcorn flour and potato flour in a volume to volume ratio of about 3:1, wherein the popcorn flour has a density in the range of about 60 grams—to about 160 grams per cup.

5. The flour composition of claim 4, wherein the popcorn flour has a density of about 70 grams—to about 120 grams per cup.

6. The flour composition of claim 5, wherein the popcorn flour has a density of about 80 grams.

7. A food product pre-mix composition comprising popcorn flour and potato flour in a ratio in the range of about 1:1 to about 3:1, and one or more additional ingredients for preparing said food product.

8. A method of preparing a food product comprising: mixing flour composition comprising popcorn flour and potato flour in a (w/w) ratio of about 1:1 to about 3:1 with one or more ingredients.

9. The food product pre-mix composition according to claim 7, wherein the food product is selected from the group consisting of: cookies, biscuits, slices, tray bakes, brownies, cakes, puddings, tarts, pies, breads, pasta, noodles, muffins, crackers, crumbs, doughnuts, pastries, crumpets, dumplings, scones, pancakes, pikelets, crepes, flat breads, wrap and pocket breads, pizza bases noodles, and wanton wrappers.

10. The food product premix composition according to claim 7, wherein the food product is selected from the group consisting of: cakes, biscuits, cookies, puddings, pancakes, pikelets, muffins, tray bakes, brownies and slices.

11. The method according to claim 8, wherein the food product is selected from the group consisting of: cookies, biscuits, slices, tray bakes, brownies, cakes, puddings, tarts, pies, breads, pasta, noodles, muffins, crackers, crumbs, doughnuts, pastries, crumpets, dumplings, scones, pancakes, pikelets, crepes, flat breads, wrap and pocket breads, pizza bases noodles, and wanton wrappers.

12. The method according to claim 8, wherein the food product is selected from the group consisting of: cakes, biscuits, cookies, puddings, pancakes, pikelets, muffins, tray bakes, brownies, and slices.

13. The flour composition of claim 2, wherein the (w/w) ratio is about 1.4:1.

14. The flour composition of claim 2, wherein the (w/w) ratio is about 1.5:1.

15. The flour composition of claim 2, wherein the (w/w) ratio is about 1.6:1.

16. The flour composition of claim 2, wherein the (w/w) ratio is about 1.8:1.

17. The flour composition of claim 5, wherein the popcorn flour has a density of about 90 grams per cup.

18. The flour composition of claim 5, wherein the popcorn flour has a density of about 100 grams per cup.

19. The flour composition of claim 5, wherein the popcorn flour has a density of about 110 grams per cup.
